(19) United States
(12) Patent Application Publication
(10) Pub. No.: US 2025/0181775 A1
(43) Pub. Date: Jun. 5, 2025

(54) CALCULATION APPARATUS, CALCULATION METHODS, AND PROGRAMS

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/842,037

(22) PCT Filed: Mar. 31, 2022
(86) PCT No.: PCT/JP2022/016502

§ 371 Date: Aug. 27, 2024

(51) Int. Cl. G06F 21/64; H04L 9/00

(52) U.S. Cl. CPC G06F 21/64; H04L 9/50

(57) ABSTRACT

A computing device serving as a node of a blockchain executes processing for obtaining consensus using a consensus algorithm of the blockchain, and stores, in a block of the blockchain, a one-way function value of at least one of secret information obtained by securely distributing information based on original information and a secure computation result obtained by performing secure computation on the secret information in a case in which the consensus is obtained using the consensus algorithm of the blockchain.

### TECHNICAL FIELD

The present invention relates to a secure computation technique, and particularly to a distributed secure computation technique.

### BACKGROUND ART

A distributed secure computation technique of using shares obtained by securely distributing information based on original information to obtain shares obtained by securely distributing operation results of specified computing without restoring the original information and the operation results is known (see, for example, NPL 1 or the like).

In the known distributed secure computation technique, data related to secure computation can be referred to through an interface of a computing device for performing the secure computation.

### CITATION LIST

### Non Patent Literature

[NPL 1] Koji Chida, Koki Hamada, Dai Ikarashi, Katsumi Takahashi, “A Three-Party Secure Function Evaluation with Lightweight Verifiability Revisited,” Oct. 12, 2010, Computer Security Symposium (CSS), 2010, pp. 555-560.

### SUMMARY OF INVENTION

### Technical Problem

However, the known distributed secure computation technique has a problem that it is difficult to monitor and verify irregular processing of a computing device performing secure computation.

The present invention has been made in view of these points and an object thereof is to provide a technique that can monitor and verify irregular processing of secure computation.

### Solution to Problem

A computing device serving as a node of a blockchain executes processing for obtaining consensus using a consensus algorithm of the blockchain, and stores, in a block of the blockchain, a one-way function value of at least one of secret information obtained by securely distributing information based on original information and a secure computation result obtained by performing secure computation on the secret information in a case in which the consensus is obtained using the consensus algorithm of the blockchain.

### Advantageous Effects of Invention

Thus, it is possible to monitor and verify irregularity of the secure computation.

### BRIEF DESCRIPTION OF DRAWINGS

FIG. 1 is a block diagram showing a configuration of a secure computation system of an embodiment.

FIG. 2A is a block diagram showing a functional configuration of a client device of the embodiment, and FIG. 2B is a block diagram showing a functional configuration of the secure computation device (computing device) of the embodiment.

FIG. 3 is a conceptual diagram showing an example of processing in the case of using a plurality of blockchains.

FIG. 4 is a conceptual diagram for showing an example of processing in the case of using one blockchain.

FIG. 5 is a conceptual diagram showing another example of processing in the case of using one blockchain.

FIG. 6 is a block diagram showing a hardware configuration of a device of the embodiment.

### DESCRIPTION OF EMBODIMENTS

Embodiments of the present invention will be described below with reference to the drawings.

### First Embodiment

First, a first embodiment of the present invention will be described.

### <Configuration>

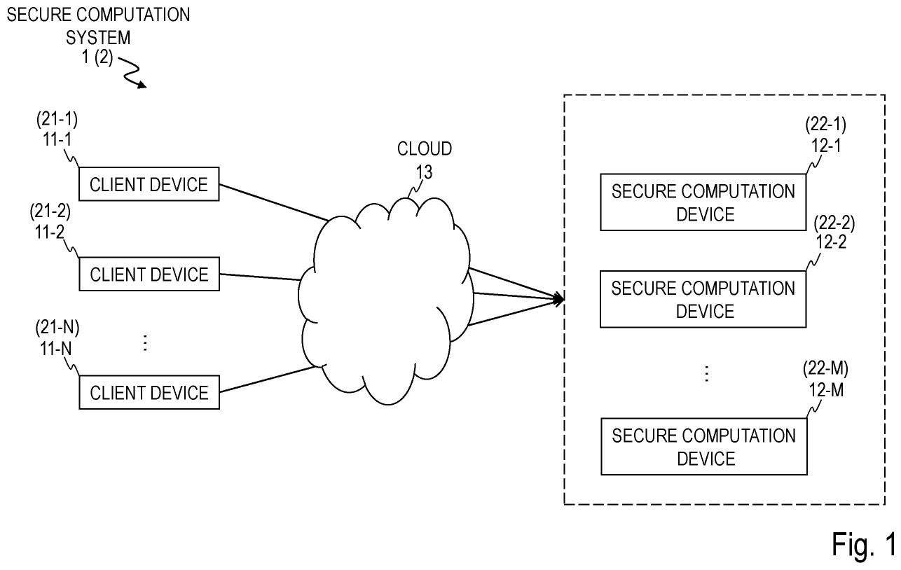

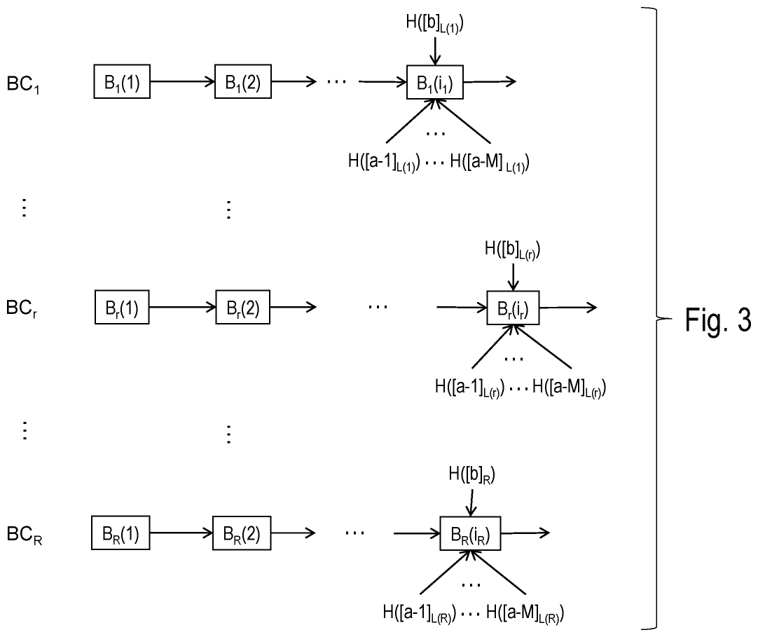

As illustrated in FIG. 1, a secure computation system 1 of the present embodiment includes N client devices 11-1, . . . , 11-N, and M secure computation devices 12-1, . . . , 12-M (computing devices), which are communicatively connected to a cloud 13 on a network. N is an integer of 1 or more, and N is an integer of 2 or more, for example. M is an integer of 2 or more, and M is an integer of 3 or more, for example. The cloud 13 includes a single or a plurality of server devices and a communication network, and these server devices are provided with a blockchain platform (for example, a program) that has a smart contract function. This smart contract function is provided with processing content of secure computation executed by the secure computation devices 12-1, . . . , 12-M. For example, the processing content of secure computation is stored in ledger information of the blockchain platform. As shown in FIG. 3, at least R blockchains BC₁, . . . , BC_{R} are set in the blockchain platform of the present embodiment. R is an integer of 2 or more and M or less, and r=1, . . . , R. For example, R=3.

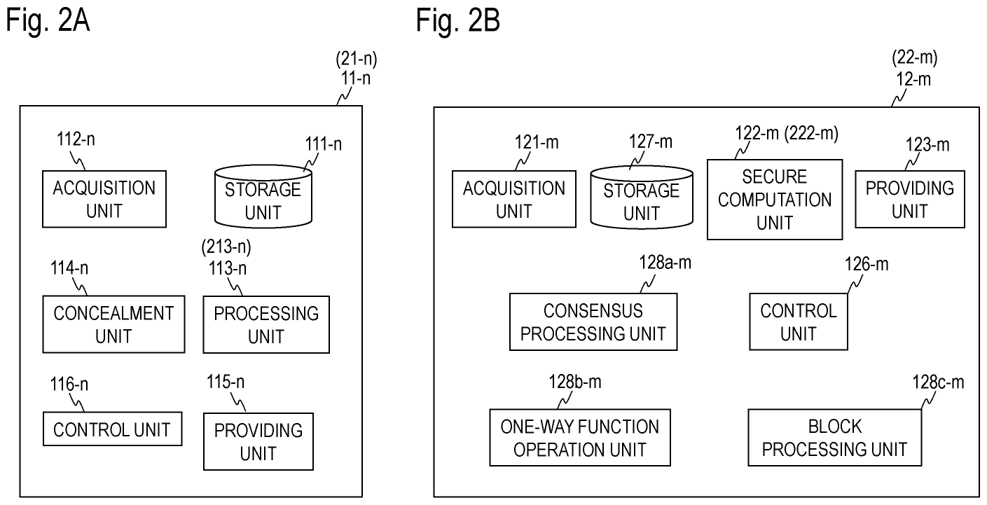

As illustrated in FIG. 2A, a client device 11-n of the present embodiment includes a storage unit 111-n, an acquisition unit 112-n, a processing unit 113-n, a concealment unit 114-n, a providing unit 115-n, and a control unit 116-n. The client device 11-n executes each processing on the basis of the control unit 116-n. Information (data) obtained by each unit of the client device 11-n is stored in the storage unit 111-n, and read out and used as necessary. The client device 11-n is any blockchain node of the blockchain platform of the cloud 13. The acquisition unit 112-n of the client device 11-n is configured to be able to receive a processing request from the smart contract function of the blockchain platform of the cloud 13. Preferably, the acquisition unit 112-n blocks requests other than the processing request from the smart contract function. Also, n=1, . . . , N, and configurations and processing regarding n are the same for all n=1, . . . , N unless otherwise specified. However, the content of data (information) to be handled may vary depending on a value of n.

As illustrated in FIG. 2B, the secure computation device 12-m of the present embodiment includes an acquisition unit 121-m, a secure computation unit 122-m, a providing unit 123-m, a control unit 126-m, a storage unit 127-m, a consensus processing unit 128a-m, a one-way function operation unit 128b-m, and a block processing unit 128c-m. The secure computation device 12-m executes each processing on the basis of the control unit 126-m. Information (data) obtained by each unit of the secure computation device 12-m is stored in the storage unit 127-m, and read and used as necessary. Also, m=1, . . . , M, and configurations and processing regarding m are the same for all m=1, . . . , M unless otherwise specified. However, the content of data (information) to be handled may vary depending on a value of m.

### <Secure Distributing Processing>

The acquisition unit 112-n of the client device 11-n receives information identifying the original information a-n and stores the original information a-n in the storage unit 111-n. The information identifying the original information a-n may be information representing the original information a-n itself or may be secret information (for example, ciphertext or a secure distributing value of the original information) of the original information a-n. Also, the original information a-n is, for example, plain text. Examples of the original information a-n include information that should be prevented from leaking to the outside, such as personal information, medical information, trade secret information, statistical information, technical information, or information (model parameters and the like) that identifies a learned model using these as learning data. The acquisition unit 112n stores the original information a-n in the storage unit 111-n in a case in which information representing the original information a-n itself is received and stores the original information a-n restored from the secret information in the storage unit 111-n (step S111-n) in a case in which the secret information of the original information a-n is received.

The processing unit 113-n reads the original information a-n from the storage unit 111-n and sends information based on the original information a-n to the concealment unit 114-n. Also, the “information based on the original information a-n” may be the original information a-n itself or may be information obtained by applying some processing to the original information a-n. In the latter case, the processing unit 113-n applies some processing to the original information a-n and sends the information obtained by the processing to the concealment unit 114-n (step S113-n).

The concealment unit 114-n securely distributes information based on the sent original information a-n to obtain and output R pieces of secret information [a-n]_{L(1)}, . . . , [a-n]_{L(R)}. These pieces of secret information [a-n]_{L(1)}, . . . , [a-n]_{L(R)} are shares (sometimes referred to as “fragments”) in a secure distributing method. The secure distributing method may be any type. An example of the secure distributing method is a “threshold secret distributing method” that has a characteristic that “source information (for example, information based on original information) can be restored when a predetermined number of shares (for example, secret information) or more are collected, but no information (for example, the information based on the original information) can be obtained from below the predetermined number of shares (for example, the secret information).” The secret information [a-n]_{L(1)}, . . . , [a-n]_{L(R)} is stored in the storage unit 111-n (step S114-n).

### <Secure Computing Processing>

Based on this premise, secure computation processing is executed.

First, consensus processing units 128a-1, . . . , 128a-M (FIG. 2B) of the secure computation devices 12-1, . . . , 12-M are connected to the blockchain platform of the cloud 13 and execute processing for obtaining consensus using a consensus algorithm of the blockchains BC₁, . . . , BC_{R} of the blockchain platform. Each consensus processing unit 128a-m executes processing for obtaining consensus using a consensus algorithm of at least one blockchain BCᵣ. For example, each consensus processing unit 128a-m executes processing for obtaining consensus using each consensus algorithm of all blockchains BC₁, . . . , BC_{R}. The consensus algorithm may be any one as long as it provides consensus to a particular device (a single device or a plurality of devices). Information that has been stored and/or information to be stored in the latest block of the blockchain BCᵣ by a device that has obtained consensus using a consensus algorithm of the blockchain BCᵣ is handled as being legitimate, and a next block of the blockchain BCᵣ is further generated on the basis of the latest block. The consensus algorithm may be newly executed in the next block, or the device that has obtained the consensus in the previous block may continue to obtain consensus in the next block. For example, consensus may be continuously given to a device that has obtained consensus in a block until a subsequent series of processing (for example, secure computation) ends. Specific examples of the consensus algorithm include Proof of Work (POW), Proof of Stake (POS), Proof of Importance (POI), Proof of Consensus (PoC), and the like. However, the present invention is not limited thereto. In addition, a specific example of the processing for obtaining the consensus using the consensus algorithm is mining. However, the present invention is not limited thereto. Hereinafter, a device that has obtained consensus using the consensus algorithm of the blockchain BCᵣ will be referred to as a leader LEADᵣ. In the present embodiment, any one secure computation device 12-r is selected as the leader LEADᵣ for each blockchain BCᵣ using the consensus algorithm. Mutually different secure computation devices 12-r1 and 12-r2 are preferably selected as leaders LEADᵣ₁ and LEADᵣ₂ for mutually different blockchains BCᵣ1 and BCᵣ₂. Here, r1 and r2∈{1, . . . , M} and r1≠r2. However, for mutually different blockchains BCᵣ₁ and BCᵣ₂, the same secure computation device 12-r may be selected as the leaders LEADᵣ₁ and LEADᵣ₂ (step S128a-m).

When secure computation devices 12-L(1), . . . , 12-L(R) are selected as the leaders LEAD₁, . . . , LEAD_{R} for the blockchains BC₁, . . . , BC_{R}, the smart contract function of the blockchain platform of the cloud 13 transmits a processing request to these secure computation devices 12-L(1), . . . , 12-L(R) to execute secure computation. In addition, {L(1), . . . , L(R)}⊆{1, . . . , M}. This processing request includes information on a transmission destination of the secure computation result. For example, the transmission destination of the secure computation result may be all the client devices 11-1, . . . , 11-N, some of the client devices 11-1, . . . , 11-N, or may include other devices (step S131).

An acquisition unit 121-L(r) (FIG. 2B) of a secure computation device 12-L(r) (where r=1, . . . , R) serving as the leader LEADᵣ acquires (receives) the processing request. The acquisition unit 121-L(r) that has acquired the processing request is connected to acquisition units 112-1, . . . , 112-N (FIG. 2A) of the client devices 11-1, . . . , 11-N and executes processing for proving that the secure computation device 12-L(r) is the leader LEADᵣ. There is no limitation to this processing, but for example, the acquisition unit 121-L(r) proves that the secure computation device 12-L(r) is the leader LEADᵣ using the result of the above-described consensus algorithm, an electronic signature, and the like. In a case in which the acquisition unit 112-n of the client device 11-n recognizes the secure computation device 12-L(r) as the leader LEADᵣ, the providing unit 115-n of the client device 11-n extracts secret information [a-N] L(r) from the storage unit 111-n and transmits the secret information [a-N] L(r) to the secure computation device 12-L(r) (where r=1, . . . , R) serving as the leader LEADᵣ (step S115-n).

The acquisition unit 121-L(r) of the secure computation device 12-L(r) (FIG. 2B) serving as the leader LEADᵣ acquires (receives) the secret information [a-N]_{L(r)} and stores it in a storage unit 127-L(r). When all pieces of the secret information [a-1]_{L(r)}, . . . , [a-N]_{L(r)} transmitted from the client devices 11-1, . . . , 11-N are stored in the storage unit 127-L(r), the secure computation unit 122-L(r) extracts the secret information [a-1]_{L(r)}, . . . , [a-N]_{L(r)} from the storage unit 127-L(r). Further, the secure computation unit 122-L(r) performs secure computation on the secret information [a-1]_{L(r)}, . . . , [a-N]_{L(r)} in accordance with the processing request (the processing request from the smart contract function using the blockchains), and obtain and output a secure computation result [b]_{L(r)}. The secure computation result [b]_{L(r)} is sent to a providing unit 123-L(r) and a one-way function operation unit 128b-L(r). Also, the secret information [a-1]_{L(r)}, . . . , [a-N]_{L(r)} serving as a target of the secure computation is also sent to the one-way function operation unit 128b-L(r) (step S122-L(r)).

The providing unit 123-L(r) transmits the secure computation result [b]_{L(r)} to the transmission destination included in the processing request. For example, the secure computation result [b]_{L(r)} is transmitted to the client devices 11-1, . . . , 11-N. The acquisition unit 112-n of the client device 11-n (FIG. 2A) acquires (receives) the transmitted secure computation result [b]_{L(r)} and stores it in the storage unit 111-n. The acquisition unit 112-n may further restore the secure computation result [b]_{L(r)} from a plurality of secure computation results [b]_{L(r)} (where L(r)∈{L(1), . . . , L(R)}) to obtain an operation result b and store the operation result b in the storage unit 111-n. Further, the operation result b or the secure computation result [b]_{L(r)} may be information identifying new original information a-n (step S112-n).

Also, the one-way function operation unit 128b-L(r) of the secure computation device 12-L(r) (FIG. 2B) that has received the secret information [a-1]_{L(r)}, . . . , [a-N]_{L(r)} and the secure computation result [b]_{L(r)} (where r=1, . . . , R) obtains and outputs a one-way function value of at least one of the secret information [a-1]_{L(r)}, . . . , [a-N]_{L(r)} and the secure computation result [b]_{L(r)}.

### Example 1-1

For example, the one-way function operation unit 128b-L(r) obtains and outputs one-way function values H₁([a-1]_{L(r)}), . . . , H_{N}([a-N]_{L(r)}), and H_{N+1}([b]_{L(r)}) of each of the secret information [a-1]_{L(r)}, . . . , [a-N]_{L(r)} and the secure computation result [b]_{L(r)}. However, H_{β}(α) represents a one-way function value obtained by applying a one-way function H_{β} to α. The one-way function H_{β} may be any function as long as it is cryptographically unlikely to collide with an input value. For example, the one-way function H_{β} may be a cryptographic hash function or may be a cryptographic function of a deterministic cryptosystem into which an encryption key is input. In the former case, the one-way function value is a hash value, and in the latter case, the one-way function value is ciphertext. One-way functions H₁, . . . , H_{N}, and H_{N+1} may be the same (H=H₁= . . . =H_{N}=H_{N+1}), or at least some of them may be different from each other.

### Example 1-2

Alternatively, for example, the one-way function operation unit 128b-L(r) may obtain and output one-way function values H₁([a-1]L(r), . . . , [a-N]L(r), and [b]_{L(r)}) of function values (for example, bit coupling values) of the secret information [a-1]_{L(r)}, . . . , [a-N]_{L(r)} and the secure computation result [b]_{L(r)}.

### Example 1-3

Alternatively, for example, the one-way function operation unit 128b-L(r) may obtain and output one-way function values H₁([a-1]_{L(r)}, . . . , [a-N]_{L(r)} of function values of the secret information [a-1]_{L(r)}, . . . , [a-N]_{L(r)} and a one-way function value H2([b]_{L(r)}) of the secure computation result [b]_{L(r)}.

### Example 1-4

Alternatively, for example, the one-way function operation unit 128b-L(r) may obtain and output only the one-way function values H₁([a-1]_{L(r)}, . . . , [a-N]_{L(r)}, or only the one-way function value H2([b]_{L(r)}). In addition, for example, the one-way function operation unit 128b-L(r) may obtain and output one-way function values of function values (for example, bit coupling values) of at least one of the secret information [a-1]_{L(r)}, . . . , [a-N]_{L(r)} and the secure computation result [b]_{L(r)} and other information.

However, these are merely examples and do not limit the present invention. The single or plurality of one-way function values output from the one-way function operation unit 128b-L(r) are sent to a block processing unit 128c-L(r) (step S128b-L(r)).

Each block processing unit 128c-L(r) (where r=1, . . . , R) stores the received one-way function value in the latest block Bᵣ(iᵣ) of each blockchain BCᵣ. Here, the block Bᵣ(iᵣ) is a block in which the secure computation device 12-L(r) has obtained the consensus, and ir is an index of a positive integer representing a block of the blockchain BCᵣ. FIG. 3 illustrates a case in which the one-way function values are H₁ ([a-1]L(r), . . . , H_{N}([a-N]_{L(r)}), and H_{N+1} ([b]_{L(r)}) of Example 1-1, and H=H₁= . . . =H_{N}=H_{N+1}. In this case, the block processing unit 128c-L(r) stores the one-way function values H([a-1]L(r), . . . , H([a-N]_{L(r)}), and H([b]_{L(r)}) in the block Bᵣ(iᵣ). After that, new blocks following the block Bᵣ(iᵣ) continue to be generated (step S128c-L(r)).

### Features of Present Embodiment

In the present embodiment, for r=1, . . . , R, the secure computation device 12-L(r) (computing device) serving as a node of the blockchain BCᵣ executes processing for obtaining the consensus using the consensus algorithm of the blockchain BCᵣ and in a case in which the consensus is obtained using the consensus algorithm of the blockchain BCᵣ, stores the one-way function value of at least one of the secret information obtained by securely distributing the information based on the original information and the secure computation result obtained by performing secure computation on the secret information in the block Bᵣ(iᵣ) of the blockchain BCᵣ. As long as safety of the blockchain BCᵣ is maintained, the information stored in the block Bᵣ(iᵣ) cannot be altered. Thus, it is possible to monitor and verify the processing performed by the secure computation device 12-L(r).

Also, the secure computation unit 122-L(r) of the secure computation device 12-L(r) of the present embodiment performs secure computation on the secret information [a-1]_{L(r)}, . . . , [a-N]_{L(r)} in accordance with the processing request from the smart contract function using the blockchain BCᵣ to obtain the secure computation result [b]_{L(r)}. Thus, it is possible to control the secure computation processing of the secure computation device 12-L(r) to inhibit irregularity of the secure computation device 12-L(r).

Further, the secure computation device 12-L(r) of the present embodiment blocks requests other than the processing request from the smart contract function. Thus, it is possible to inhibit irregularity of the secure computation device 12-L(r).

Also, the R secure computation devices 12-L(1), . . . , 12-L(R) of the present embodiment store the above-described one-way function values respectively to the blocks of the R blockchains BC₁, . . . , BC_{R}. That is, a secure computation device 12-L(r1) (computing device) executes processing for obtaining consensus using a consensus algorithm of the blockchain BCᵣ₁, and in a case in which the consensus is obtained using the consensus algorithm of the blockchain BCᵣ₁, stores a one-way function value of at least one of the secret information obtained by securely distributing the information based on the original information and the secure computation result obtained by performing secure computation on the secure information in a block Bᵣ₁ (iᵣ₁) of the blockchain BCᵣ₁. Further, another secure computation device 12-L(r2) (computing device) executes processing for obtaining consensus using a consensus algorithm of another blockchain BCᵣ₂ other than the blockchain BCᵣ₁, and in a case in which the consensus is obtained using the consensus algorithm of the blockchain BCᵣ₂, stores a one-way function value of at least one of other secret information obtained by securely distributing the information based on the original information and another secret information secure computation result obtained by performing secure computation on the other secret information in a block Bᵣ₂ (iᵣ₂) of the other blockchain BCᵣ₂. However, r1≠r2, and r1 and r2∈{1, . . . , R}. Thus, even when safety of any blockchain is impaired, it is possible to monitor and verify the processing performed by the secure computation device as long as security of the other blockchain is maintained.

### Modified Example 1 of First Embodiment

Differences from the first embodiment will be mainly described below, and the matters that have already been described will be simplified. In the first embodiment, for the R blockchains BC₁, . . . , BC_{R}, the secure computation devices 12-L(1), . . . , 12-L(R) are selected as the leaders LEAD₁, . . . , LEAD_{R}, and the secure computation devices 12-L(1), . . . , 12-L(R) store the above-described one-way function values respectively in the blocks B₁(i₁), . . . , B_{R}(i_{R}) of the blockchains BC₁, . . . , BC_{R}. However, the R secure computation devices 12-L(1), . . . , 12-L(R) may be selected as the leaders LEAD₁, . . . , LEAD_{R} in parallel to one blockchain BC₁ of the blockchain platform of the cloud 13, and the secure computation devices 12-L(1), . . . , 12-L(R) may store the above-described one-way function values in the block B₁(i₁) of the blockchain BC₁. This will be described in detail below.

### <Configuration>

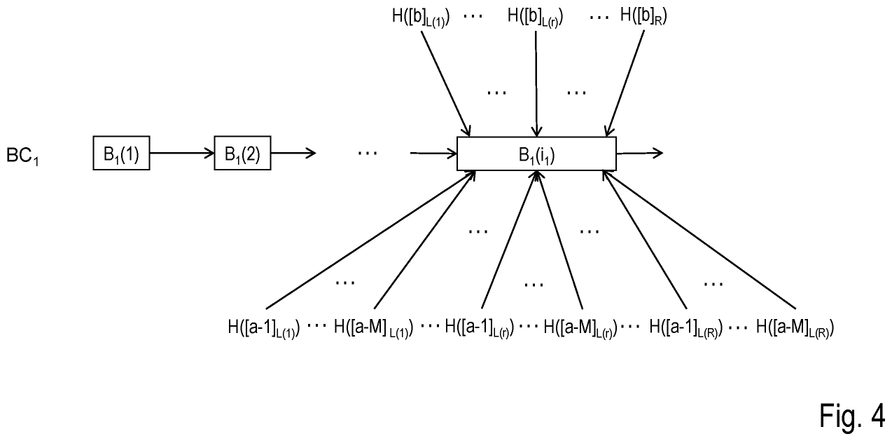

In the present modified example, as illustrated in FIG. 4, at least one blockchain BC₁ may be set in the blockchain platform of the cloud 13. Others are the same as the configuration of the first embodiment.

### <Secure Distributing Processing>

This is the same as the first embodiment.

### <Secure Computing Processing>

First, instead of the processing of step S128a-m of the first embodiment, the consensus processing unit 128a-m of each secure computation device 12-m (where m=1, . . . , M) is connected to the blockchain platform of the cloud 13 and executes processing for obtaining consensus using the consensus algorithm of the blockchain BC₁. In the present modified example, any R secure computation devices 12-L(1), . . . , 12-L(R) are selected as the leaders LEAD₁, . . . , LEAD_{R} for the blockchain BC₁ using the consensus algorithm ({L(1), . . . , L(R)}⊆{1, . . . , M}) (step S128a(1)-m).

After that, the processing described in steps S131, S115-n, S122-L(r), S112-n, and S128b-L(r) described in the first embodiment are executed.

After that, the block processing unit 128c-L(r) of each secure computation device 12-L(r) (where r=1, . . . , R) stores the received one-way function value in the latest block B₁(i₁) of the blockchain BC₁ (the block for which the secure computation device 12-L(r) has obtained the consensus using the consensus algorithm of the blockchain BC₁). FIG. 4 illustrates the case in which the one-way function values are H₁([a-1]L(r), . . . , H_{N}([a-N]_{L(r)}), and H_{N+1}([b]_{L(r)}) of Example 1-1 and H=H₁= . . . =H_{N}=H_{N+1} (step S128c(1)-L(r)). Others are the same as the first embodiment.

### Features of Present Modified Example

In the present modified example, the secure computation device 12-L(r1) (computing device) serving as a node of the blockchain BC₁ executes processing for obtaining consensus using the consensus algorithm of the blockchain BC₁, and when the consensus is obtained using the consensus algorithm of the blockchain BC₁, stores the one-way function value of at least one of the secret information obtained by securely distributing the information based on the original information and the secure computation result obtained by performing secure computation on the secret information in the block B₁(i₁) of the blockchain BC₁. Further, another secure computation device 12-L(r2) (another computing device) serving as another node of the blockchain BC₁ also executes processing for obtaining consensus using the consensus algorithm of the same blockchain BC₁, and in a case in which the consensus is obtained using the consensus algorithm of the blockchain BC₁, stores the one-way function value of at least one of other secret information obtained by securely distributing the information based on the original information and another secret information secure computation result obtained by performing secure computation on the other secret information in the block B₁(i₁) of the blockchain BC₁. The block B₁(i₁) corresponds to a block of a blockchain in which a one-way function value of at least one of other secret information and another secure computation result is stored by another computing device. However, r1≠r2, and r1 and r2∈{1, . . . , R}. Even in this case, as in the first embodiment, it is possible to monitor and verify the processing performed by the secure computation device 12-L(r).

### Modified Example 2 of First Embodiment

In the first embodiment, for the R blockchains BC₁, . . . , BC_{R}, the secure computation devices 12-L(1), . . . , 12-L(R) are selected as the leaders LEAD₁, . . . , LEAD_{R}, and the secure computation devices 12-L(1), . . . , 12-L(R) store the above-described one-way function values respectively in the blocks B₁(i₁), . . . , B_{R}(i_{R}), of the blockchains BC₁, . . . , BC_{R}. However, the R secure computation devices 12-L(1), . . . , 12-L(R) may be selected as the leaders LEAD₁, . . . , LEAD_{R} in order (in series) for a plurality of blocks B₁(i₁), . . . , B₁ (i_{R}) of one blockchain BC₁ in the blockchain platform of the cloud 13, and each secure computation device 12-L(r) may store the above-described one-way function value in order in the block B₁ (iᵣ) for which it is selected as the leader LEADᵣ. However, since the secure computation is performed after the R secure computation devices 12-L(1), . . . , 12-L(R) are selected as the leaders LEAD₁, . . . . LEAD_{R}, the one-way function value of the information including the secure computation result [b]_{L(r)} is stored in the block B₁(i_{R}) by the secure computation device 12-L(R) finally selected as the leader LEAD_{R}. Also, by performing secure computation after the R secure computation devices 12-L(1), . . . , 12-L(R) are selected as the leaders LEAD₁, . . . , LEAD_{R}, it is also possible to perform secure computation (for example, multiplication in secure computation) accompanied by communication among the secure computation devices 12-L(1), . . . , 12-L(R). This will be described in detail below.

### <Configuration>

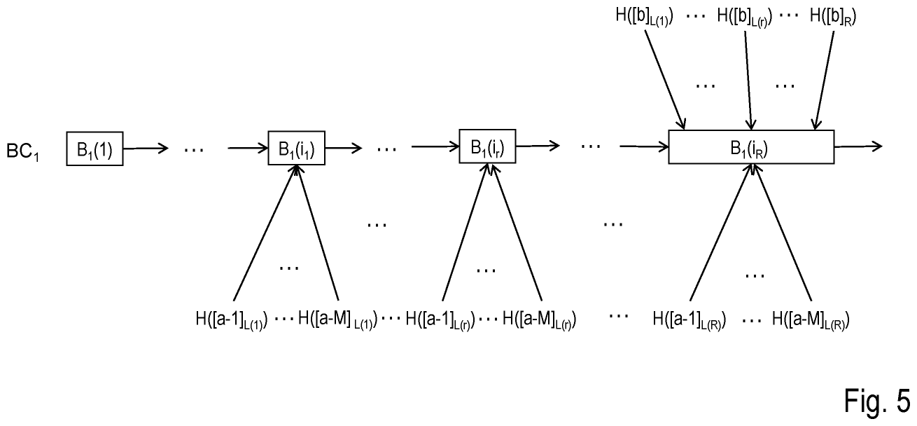

In the present modified example, as illustrated in FIG. 5, at least one blockchain BC₁ may be set in the blockchain platform of the cloud 13. Others are the same as the configuration of the first embodiment.

### <Secure Distributing Processing>

This is the same as the first embodiment.

First, instead of the processing of step S128a-m of the first embodiment, the consensus processing unit 128a-m of each secure computation device 12-m (where m=1, . . . , M) is connected to the blockchain platform of the cloud 13 and executes processing for obtaining consensus using the consensus algorithm of the blockchain BC₁. In the present modified example, any one secure computation device 12-L(r) is selected as the leaders LEAD₁, . . . , LEAD_{R} for the blockchain BC₁ using the consensus algorithm (where r∈{1, . . . , M}) (step S128a(2)-m).

When any secure computation device 12-L(r) is selected as the leader LEADᵣ, the smart contract function of the blockchain platform of the cloud 13 transmits a processing request for obtaining the secret information for secure computation to the secure computation device 12-L(r) instead of the processing of step S131 of the first embodiment (step S131(2)).

Next, instead of the processing of step S115-n of the first embodiment, the acquisition unit 121-L(r) (FIG. 2B) of the secure computation device 12-L(r) serving as the leader LEADᵣ acquires (receives) the processing request. In accordance with the processing request, the acquisition unit 121-L(r) is connected to the acquisition units 112-1, . . . , 112-N (FIG. 2A) of the client devices 11-1, . . . , 11-N, and executes processing for proving that the secure computation device 12-L(r) is the leader LEADᵣ. When the acquisition unit 112-n of the client device 11-n recognizes the secure computation device 12-L(r) as the leader LEADᵣ, the providing unit 115-n of the client device 11-n extracts the secret information [a-N]_{L(r)} from the storage unit 111-n and transmits the secret information [a-N]_{L(r)} to the secure computation device 12-L(r) serving as the leader LEADᵣ (step S115(2)-n).

Instead of step S122-L(r) of the first embodiment, the acquisition unit 121-L(r) of the secure computation device 12-L(r) (FIG. 2B) serving as the leader LEAD acquires (receives) the secret information [a-N]_{L(r)} and stores it in the storage unit 127-L(r). When all pieces of the secret information [a-1]_{L(r)}, . . . , [a-N]_{L(r)} transmitted from the client devices 11-1, . . . , 11-N are stored in the storage unit 127-L(r), the one-way function operation unit 128b-L(r) extracts the secret information [a-1]_{L(r)}, . . . , [a-N]_{L(r)} from the storage unit 127-L(r). The one-way function operation unit 128b-L(r) obtains and outputs the one-way function values of the secret information [a-1]_{L(r)}, . . . , [a-N]_{L(r)}.

### Example 2-1

For example, the one-way function operation unit 128b-L(r) obtains and outputs the one-way function values H₁([a-1]_{L(r)}), . . . , H_{N}([a-N]_{L(r)}) of the secret information [a-1]_{L(r)}, . . . , [a-N]_{L(r)}.

### Example 2-2

Alternatively, for example, the one-way function operation unit 128b-L(r) may obtain and output the one-way function values H₁([a-1]_{L(r)}, . . . , [a-N]_{L(r)}) of the function values (for example, bit coupling values) of the secret information [a-1]_{L(r)}, . . . , [a-N]_{L(r)}.

### Example 2-3

Alternatively, for example, the one-way function operation unit 128b-L(r) may obtain and output the one-way function values of the function values (for example, bit coupling values) of the secret information [a-1]_{L(r)}, . . . , [a-N]_{L(r)} and other information.

However, these are merely examples and do not limit the present invention. The single or plurality of one-way function values output from the one-way function operation unit 128b-L(r) are sent to the block processing unit 128c-L(r) (step S128b(2)-L(r)).

Next, as illustrated in FIG. 5, instead of the processing of step S128c-L(r) described in the first embodiment, the block processing unit 128c-L(r) stores the received one-way function values in the latest block B₁ (iᵣ) of the blockchain BC₁. The block B₁(iᵣ) is a block for which the secure computation device 12-L(r) obtains the consensus (step S128c(2)-L(r)).

The processing of these steps S128a(2)-m, S131(2), and SS115(2)-n, and steps S128b(2)-L(r) and S128c(2)-L(r) are executed in order in series for r=1, . . . , R (FIG. 5). After that, the secure computation unit 122-L(r) of the acquisition unit 121-L(r) of the secure computation device 12r-L(r) (FIG. 2B) serving as each leader LEADᵣ (where r=1, . . . , R) extracts the secret information [a-1]_{L(r)}, . . . , [a-N]_{L(r)} from the storage unit 127-L(r). Further, the secure computation unit 122-L(r) performs secure computation on the secret information [a-1]_{L(r)}, . . . , [a-N]_{L(r)} in accordance with the above-described processing request (processing request from the smart contract function using the blockchain) to obtain and output the secure computation result [b]_{L(r)}. Each secure computation result [b]_{L(r)} is sent to the providing unit 123-L(r) and the one-way function operation unit 128b-L(r) (step S122(2)-L(r)).

The providing unit 123-L(r) transmits the secure computation result [b]_{L(r)} to the transmission destination included in the above-described processing request. The acquisition unit 112-n of the client device 11-n (FIG. 2A) acquires (receives) the transmitted secure computation result [b]_{L(r)} and stores it in the storage unit 111-n. The acquisition unit 112-n may further restores the secure computation result [b]_{L(r)} from a plurality of secure computation results [b]_{L(r)} (where L(r)∈{L(1), . . . , L(R)}) to obtain the operation result b and store the operation result b in the storage unit 111-n. Further, the operation result b or the secure computation result [b]_{L(r)} may be information identifying new original information a-n (step S112(2)-n).

Also, the one-way function operation unit 128b-L(r) of the secure computation device 12-L(r) (FIG. 2B) receiving the secure computation result [b]_{L(r)} (where r=1, . . . , R) obtains and outputs the one-way function value H([b]_{L(r)}) of the secure computation result [b]_{L(r)}. Each of the one-way function values H([b] L(1)), . . . , H([b]L(R−1)) output from the one-way function operation units 128b-L(1), . . . , 128b-L(R-1) of the secure computation devices 12-L(1), . . . , 12-L(R-1) is transmitted from providing units 123-L(1), . . . , 123-L(R-1) to the secure computation device 12-L(R). These one-way function values H([b]L(1)), . . . , H([b]L(R−1)) are received by the acquisition unit 121-L(R) of the secure computation device 12-L(R) and sent to the block processing unit 128c-L(R). In addition, the one-way function value H([b]L(R)) output from the one-way function operation unit 128b-L(R) of the secure computation device 12-L(R) is also sent to the block processing unit 128c-L(R). The block processing unit 128c-L(R) stores the received one-way function values H([b]L(1)), . . . , H([b]L(R)) in the latest block B₁(i_{R}) of the blockchain BC₁. The block B₁ (i_{R}) is a block for which the secure computation device 12-L(R) has obtained the consensus (step S128c(2)′-L(R)) (FIG. 5).

### Features of Present Modified Example

In the present modified example, after the consensus for the secure computation devices 12-L(1), . . . , 12-L(R-1) (other computing devices) is obtained using the consensus algorithm of the blockchain BC₁, the consensus for the secure computation device 12-L(R) (computing device) is obtained using the consensus algorithm of the blockchain BC₁. After the consensus for the secure computation device 12-L(R) is obtained using the consensus algorithm of the blockchain BC₁, the secure computation device 12-L(R) performs secure computation on the secret information to obtain a secure computation result, and the secure computation devices 12-L(1), . . . , 12-L(R-1) (other computing devices) perform secure computation on other secret information to obtain other secure computation results. The secure computation device 12-L(R) stores a one-way function value of the secure computation result obtained by the secure computation device 12-L(R) and one-way function values of the secure computation results obtained by the secure computation devices 12-L(1), . . . , 12-L(R-1) (other computing devices) in the latest block B₁(i_{R}) of the blockchain BC₁ (FIG. 5). Even in this way, similarly to the first embodiment, it is possible to monitor and verify the processing performed by the secure computation device 12-L(r).

Also, in the present modified example, after consensus for each secure computation device 12-L(r′) (other computing devices) (r′∈{1, . . . , R−1}) is obtained using the consensus algorithm of the blockchain BC₁, one-way function values of secret information (other secret information) obtained by each secure computation device 12-L(r′) (other computing devices) are stored one by one in blocks B₁(iᵣ′) of the blockchain BC₁ by each secure computation device 12-L(r′) (other computing devices) (FIG. 5). Thus, since the one-way function values of the secret information are stored in the blocks B₁(i_{r′}) at the time when each secure computation device 12-L(r′) receives the secret information, it is possible to monitor and verify the processing performed by the secure computation device 12-L(r) more strictly. After that, the consensus for the secure computation device 12-L(R) (computing device) is obtained using the consensus algorithm of the blockchain BC₁. After the consensus for the secure computation device 12-L(R) is obtained using the consensus algorithm of the blockchain BC₁, the secure computation device 12-L(R) performs secure computation on the secret information to obtain a secure computation result, and the secure computation devices 12-L(1), . . . , 12-L(R-1) (other computing devices) perform secure computation on the other secret information to obtain other secure computation results. The secure computation device 12-L(R) stores the one-way function value of the secure computation result obtained by the secure computation device 12-L(R) and the one-way function values of the secure computation results obtained by the secure computation devices 12-L(1), . . . , 12-L(R-1) (other computing devices) in the latest block B₁(i_{R}) of the blockchain BC₁ (FIG. 5))

Also, as a further modified example, after the consensus for each secure computation device 12-L(r′) (r′∈{1, . . . , R−1}) is obtained, the one-way function values of the secret information obtained by each secure computation device 12-L(r′) may not be stored one by one in the blocks B₁(i_{r′}) of the blockchain BC₁ by each secure computation device 12-L(r′), but these one-way function values may also be stored in the block B₁(i_{R}) by the secure computation device 12-L(R) (FIG. 4).

### Modified Example 3 of First Embodiment

In the first embodiment and the modified examples, the processing content of the secure computation executed by each secure computation device 12-m (where m=1, . . . , M) are incorporated in the blockchain platform of the cloud 13. However, the processing content of the secure computation executed by each secure computation device 12-m may be incorporated in the secure computation unit 122-m of each secure computation device 12-m. In this case, each secure computation device 12-m executes secure computation on the basis of the processing content incorporated in itself, rather than the processing request from the smart contract function. Also, the processing content of the secure computation executed by each secure computation device 12-m may be distributed and incorporated in the blockchain platform and the secure computation unit 122-m.

### Modified Example 4 of First Embodiment

In the first embodiment or the modified examples, the providing unit 123-L(r) of the secure computation device 12-L(r) may determine whether or not transmission of the secure computation result [b]_{L(r)} to a specific client device 11-n (n∈{1, . . . , N}) is allowable by consensus confirmation processing (voting processing) included in the smart contract function of the blockchain platform of the cloud 13. In this case, each secure computation device 12-L(r) executes the consensus confirmation processing, and in accordance with the result, determines whether or the transmission of the secure computation result [b]_{L(r)} to the specific client device 11-n is allowable. Here, only in a case in which the result indicating that the transmission to the specific client device 11-n is allowable is obtained, each secure computation device 12-L(r) transmits the secure computation result [b]_{L(r)} to the specific client device 11-n. Thus, the safety is further improved.

### Modified Example 5 of First Embodiment

In the first embodiment or the modified examples, the secure computation unit 122-L(r) of the secure computation device 12-L(r) obtains all the secret information [a-1]_{L(r)}, . . . , [a-N]_{L(r)}, and then executes the secure computation. However, depending on the content of the secure computation, the secure computation unit 122-L(r) may execute the secure computation using only some of the acquired secret information before obtaining all the secret information [a-1]_{L(r)}, . . . , [a-N]_{L(r)} (for example, in the case of time-out) and obtain the secure computation result [b]_{L(r)}.

### Modified Example 6 of First Embodiment

Further, using an algorithm (for example, POS) that provides consensus without mining Nonce as a consensus algorithm, the client devices 11-1, . . . , 11-N that have obtained consensus using the consensus algorithm may store the one-way function value of the secret information [a-N]_{L(r)} of the original information a-n in a block (for example, a first block) of the above-described blockchain. Thus, the safety is further improved.

### Second Embodiment

A second embodiment is a form in which the first embodiment and the modified examples are applied to federated learning using secure computation. Federated learning is a technique of performing machine learning while learning data are distributed without being aggregated. In federated learning, a plurality of model learning devices perform machine learning using learning data (local learning data) held by themselves to generate worker models (local models) and transmit the generated worker models to a federated learning device. The federated learning device generates an aggregated model (a global model) obtained by aggregating the worker models sent from the plurality of model learning devices and transmits the generated aggregated model to the plurality of model learning devices. The plurality of model learning devices receiving the aggregated model further update the aggregated model through machine learning using learning data held by themselves to generate new worker models and transmit the generated worker models to the federated learning device. By repeating such processing, each model learning device can obtain an aggregated model in which the learning data held in the plurality of model learning devices are reflected in machine learning without passing the learning data held by itself to the outside.

However, in normal federated learning, the federated learning device receives plaintext worker models from each model learning device. For that reason, the federated learning device can know the tendency of the learning data held by each model learning device on the basis of differences between the transmitted aggregated model and the received worker models.

For that reason, in the present embodiment, instead of the model learning devices transmitting the worker models to the federated learning device, the model learning devices transmit secret information of information identifying the worker models to a secure federated learning device. The secure federated learning device obtains secret information of information identifying a plurality of worker models from a plurality of model learning devices, obtains secret information of information identifying an aggregated model obtained by aggregating the plurality of worker models by secure computation using the secret information of the information identifying the plurality of worker models without obtaining the plurality of worker models, and transmits information identifying the aggregated model or secret information of the information identifying the aggregated model to the plurality of model learning devices. Each model learning device restores the information identifying the aggregated model from the secret information, updates the aggregated model by machine learning using learning data (local learning data) held by itself, to obtain a new worker model. Further, each model learning device similarly transmits secret information of information identifying the worker model to the secure federated learning device. By repeating such processing, each model learning device can obtain an aggregated model in which the learning data held in the plurality of model learning devices is reflected in machine learning while protecting information of the learning data held by itself.

In the present embodiment, the first embodiment and the modified examples are applied to such a method. In this case, the client device 11-n described in the first embodiment and the modified examples corresponds to a model learning device, and the secure computation device 12-m corresponds to a secure federated learning device. The original information a-n stored in the storage unit 111-n of the client device 11-n of the present embodiment is information identifying an aggregated model in federated learning. The information identifying the aggregated model is, for example, a group of model parameters of the aggregated model. Further, learning data D-n (local learning data) is also stored in the storage unit 111-n of the client device 11-n.

The processing unit 113-n of the client device 11-n performs machine learning using the learning data D-n read from the storage unit 111-n, updates an aggregated model identified by the original information a-n (information identifying the aggregated model) read from the storage unit 111-n to obtain a worker model, to output information identifying the worker model as information based on the original information a-n. The information identifying the worker model is, for example, a group of model parameters of the worker model. The aggregated model and the worker model are known machine learning models. There are no limitations to the aggregated model and worker model, and for example, they may be models based on a deep learning method, models based on a hidden Markov model method, models based on a support vector machine method, or models based on linear prediction. However, all the aggregated model and the worker models handled in the present embodiment are models based on the same method. The concealment unit 114-n securely distributes information identifying the worker model (information based on the original information a-n) to obtain and output R pieces of secret information [a-n]_{L(1)}, . . . , [a-n]_{L(R)} (secret information of the information identifying the worker model).

The secure computation of the present embodiment is computing for obtaining the secure computation result [b]_{L(r)}, which is secret information of information identifying an aggregated model, using the secret information [a-n]_{L(1)}, . . . , [a-N]_{L(R)}, without obtaining worker models. The secure computation device 12-L(r) (where r=1, . . . , R) obtains and outputs the secure computation result [b]_{L(r)}, which is the secret information of the information identifying the aggregated model, by the secure computation, using the secret information [a-n]L(1), . . . , [a-N]L(R). For example, when the information a-n identifying a worker model is a group of model parameters {p₁(n), . . . , p_{K}(n)} of the worker model, a group of model parameters {P₁, . . . , p_{K}} obtained by aggregating groups of model parameters {p₁(n₁), . . . , p_{K}(n₁)}, . . . , {p₁(nₘₐₓ), . . . , p_{K}(nₘₐₓ)} where {n₁, . . . , nₘₐₓ}⊆{1, . . . , N} becomes information identifying an aggregated model. For example, pₖ is a function value of a weighted linear combination value, an average value, or the like of pₖ(n₁), . . . , pₖ(nₘₐₓ). Here, k is indexes k=1, . . . , K for identifying model parameters, and K is a positive integer. The obtained secure computation result [b]_{L(r)} (where, r=1, . . . , R) is transmitted to the client device 11-n (where n=1, . . . , N). The acquisition unit 112-n of the client device 11-n receives the secure computation result [b]_{L(r)} and stores the operation result b (information identifying the aggregated model) restored from the secure computation result [b]_{L(r)} in the storage unit 111-n as new original information a-n.

After that, the above-described processing is repeated until a predetermined condition is satisfied. Thus, the federated learning that is highly safe and in which irregular processing of secure computation can be monitored and verified can be performed.

### Specific Examples

Forms in which in which the first embodiment is applied to federated learning using secure computation will be exemplified below. However, the present invention is not limited thereto.

### <Configuration>

As illustrated in FIG. 1, a secure computation system 2 of the present embodiment includes N client devices 21-1, . . . , 21-N (model learning devices) and M secure computation devices 22-1, . . . , 22-M (secure federated learning devices or computing devices), which are communicably connected to a cloud 13 on a network. As illustrated in FIG. 3, at least R blockchains BC₁, . . . , BC_{R} are set in a blockchain platform of the present embodiment.

As illustrated in FIG. 2A, a client device 21-n of the present embodiment includes a storage unit 111-n, an acquisition unit 112-n, a processing unit 213-n, a concealment unit 114-n, a providing unit 115-n, and a control unit 116-n. The client device 21-n executes each processing on the basis of the control unit 116-n. Information (data) obtained by each unit of the client device 21-n is stored in the storage unit 111-n, and read out and used as necessary. The client device 21-n is any blockchain node of the blockchain platform of the cloud 13. The acquisition unit 112-n of the client device 21-n is configured to be able to receive a processing request from a smart contract function of the blockchain platform of the cloud 13.

As illustrated in FIG. 2B, a secure computation device 22-m of the present embodiment includes an acquisition unit 121-m, a secure computation unit 222-m, a providing unit 123-m, a control unit 126-m, a storage unit 127-m, a consensus processing unit 128a-m, a one-way function operation unit 128b-m, and a block processing unit 128c-m. The secure computation device 22-m executes each processing on the basis of the control unit 126-m. Information (data) obtained by each unit of the secure computation device 22-m is stored in the storage unit 127-m, read out and used as necessary.

### <Secure Distributing Processing>

Learning data D-n is stored in the storage unit 111-n of each client device 21-n. The acquisition unit 112-n of the client device 21-n receives information (original information a-n) identifying an aggregated model in federated learning and stores the original information a-n in the storage unit 111-n. When the federated learning is not yet performed, the acquisition unit 112-n receives initial information of information identifying the aggregated model as information identifying the original information a-n. The acquisition unit 112n stores the original information a-n in the storage unit 111-n when receiving information representing the original information a-n (aggregated model) itself, and stores the original information a-n (aggregated model) restored from secret information in the storage unit 111-n when receiving the secret information of the original information a-n (step S111-n).

The processing unit 213-n reads the original information a-n (aggregated model) and the learning data D-n from the storage unit 111-n, updates the aggregated model identified by the original information a-n by machine learning using the learning data D-n to obtain a worker model, and sends information identifying the worker model (for example, a group of model parameters) to the concealment unit 114-n as information based on the original information a-n (step S213-n).

The concealment unit 114-n obtains and outputs R pieces of secret information [a-n]_{L(1)}, . . . , [a-N]_{L(R)} by securely distributing the information (information identifying the worker model) based on the sent original information a-n. The secret information [a-n]_{L(1)}, . . . , [a-N]_{L(R)} is stored in the storage unit 111-n (step S114-n).

### <Secure Computing Processing>

Based on this premise, secure computation processing is executed.

First, consensus processing units 128a-1, . . . , 128a-M (FIG. 2B) of the secure computation devices 22-1, . . . , 22-M are connected to the blockchain platform of the cloud 13 and executes processing for obtaining consensus using consensus algorithms of blockchains BC₁, . . . , BC_{R} Of the blockchain platform (Step S128a-m).

For the blockchains BC₁, . . . , BC_{R}, when secure computation devices 22-L(1), . . . , 12-L(R) are selected as leaders LEAD₁, . . . , LEAD_{R}, a smart contract function of the blockchain platform of the cloud 13 transmits processing requests to these secure computation devices 22-L(1), . . . , 22-L(R) to execute secure computation. In addition, {L(1), . . . , L(R)}⊆{1, . . . , M}. The processing request includes information about a transmission destination of a secure computation result (step S131).

An acquisition unit 121-L(r) (FIG. 2B) of a secure computation device 22-L(r) (r=1, . . . , R) serving as a leader LEADᵣ acquires (receives) the processing request. The acquisition unit 121-L(r) acquiring the processing request is connected to acquisition units 112-1, . . . , 112-N (FIG. 2A) of the client devices 21-1, . . . , 21-N and executes processing for proving that the secure computation device 22-L(r) is the leader LEADᵣ. In a case in which the acquisition unit 112-n of the client device 21-n recognizes the secure computation device 22-L(r) as the leader LEADᵣ, the providing unit 115-n of the client device 21-n extracts secret information [a-N]_{L(r)} from the storage unit 111-n and transmits it to the secure computation device 22-L(r) (where r=1, . . . , R) serving as the leader LEADᵣ (step S115-n).

The acquisition unit 121-L(r) of the secure computation device 22-L(r) (FIG. 2B) serving as the leader LEADᵣ acquires (receives) the secret information [a-N]_{L(r)} and stores it in the storage unit 127-L(r). When all pieces of secret information [a-1]_{L(r)}, . . . , [a-N]_{L(r)} transmitted from the client devices 21-1, . . . , 21-N are stored in the storage unit 127-L(r), a secure computation unit 222-L(r) extracts the secret information [a-1]_{L(r)}, . . . , [a-N]_{L(r)} from the storage unit 127-L(r). Further, the secure computation unit 222-L(r) obtains and outputs a secure computation result [b]_{L(r)}, which is secret information of the information identifying the aggregated model using the secret information [a-n]_{L(1)}, . . . , [a-N]_{L(R)} by secure computation according to the processing request without obtaining a worker model. The secure computation result [b]_{L(r)} is sent to a providing unit 123-L(r) and a one-way function operation unit 128b-L(r). The secret information [a-1]_{L(r)}, . . . , [a-N]_{L(r)} serving as a target of the secure computation is also sent to the one-way function operation unit 128b-L(r) (step S222-L(r)).

The providing unit 123-L(r) transmits the secure computation result [b]_{L(r)} to the transmission destination included in the processing request. For example, the secure computation result [b]_{L(r)} is transmitted to the client devices 21-1, . . . , 21-N. The acquisition unit 112-n of the client device 21-n (FIG. 2A) acquires (receives) the transmitted secure computation result [b]_{L(r)} and stores it in the storage unit 111-n. The acquisition unit 112-n further restores the secure computation result [b]_{L(r)} from a plurality of secure computation results [b]_{L(r)} (where L(r)∈{L(1), . . . , L(R)}) to obtain an operation result b (information identifying an aggregated model) and stores the operation result b (information identifying the aggregated model) as new original information a-n (information identifying the aggregated model) in the storage unit 111-n (step S112-n).

Further, the one-way function operation unit 128b-L(r) of the secure computation device 12-L(r) (FIG. 2B) receiving the secret information [a-1]_{L(r)}, . . . , [a-N]_{L(r)} and the secure computation result [b]_{L(r)} (where r=1, . . . , R) obtains and outputs a one-way function value of at least one of the secret information [a-1]_{L(r)}, . . . , [a-N]_{L(r)} and the secure computation result [b]_{L(r)}. The one-way function value is sent to the block processing unit 128c-L(r) (step S128b-L(r)).

Each block processing unit 128c-L(r) (where r=1, . . . , R) stores the received one-way function value in the latest block Bᵣ(iᵣ) of each blockchain BCᵣ (FIG. 3) (step S128c-L(r))).

After that, the above-described secure distributing processing and secure computation processing of the present embodiment are repeated until a predetermined end condition is satisfied. This repetition is performed while updating the operation result b (information identifying the aggregated model) as new original information a-n (information identifying the aggregated model) in step S112-n. Also, any end conditions may be used. For example, the end condition may be satisfied when the number of updates, amounts of updates, times of updates, or the like of the aggregated model reach a specified value.

### [Hardware Configuration]

The client devices 11-n and 21-n and the secure computation devices 12-m and 22-m according to each embodiment are devices configured by general-purpose or dedicated computers executing predetermined programs, which include, for example, processors (hardware processors) such as central processing units (CPUs), and memories such as random-access memories (RAMs) and read-only memories (ROMs). That is, the client devices 11-n and 21-n and the secure computation devices 12-m and 22-m according to each embodiment have, for example, processing circuitry configured to incorporate their respective units. This computer may include one processor and a memory, or may include a plurality of processors and memories. This program may be installed in the computer or may be recorded in a ROM or the like in advance. In addition, some or all processing units may be configured using electronic circuitry which realizes a processing function independently, instead of electronic circuitry which realizes a functional configuration by reading a program like a CPU. Further, electronic circuitry constituting one device may include a plurality of CPUS.

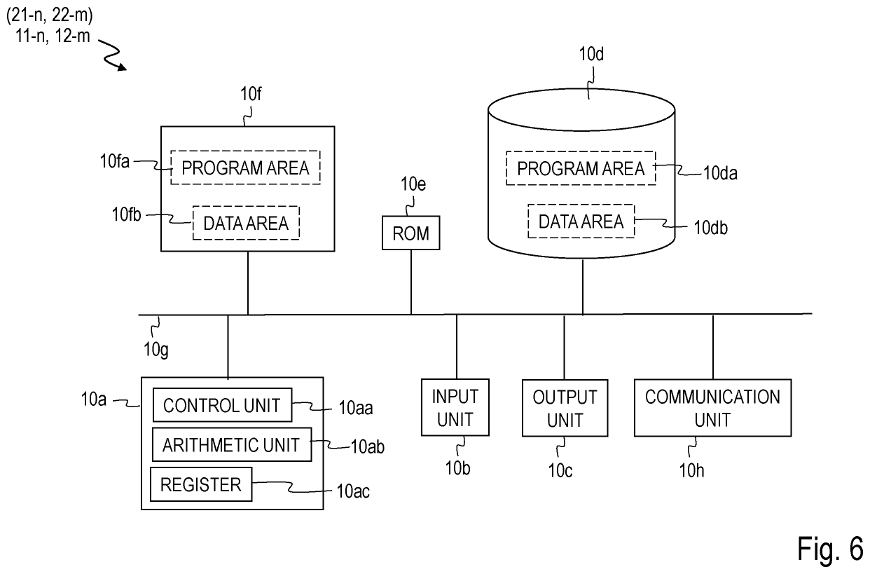

FIG. 6 is a block diagram illustrating hardware configurations of the client devices 11-n and 21-n and the secure computation devices 12-m and 22-m according to each embodiment. As illustrated in FIG. 6, the client devices 11-n and 21-n and the secure computation devices 12-m and 22-m in this example each include a central processing unit (CPU) 10a, an input unit 10b, an output unit 10c, a random access memory (RAM) 10d, a read only memory (ROM) 10e, an auxiliary storage device 10f, a communication unit 10h, and a bus 10g. The CPU 10a in this example includes a control unit 10aa, an arithmetic unit 10ab, and a register 10ac and executes various types of operation processing in accordance with various programs read in the register 10ac. In addition, the input unit 10b is an input terminal into which data is input, a keyboard, a mouse, a touch panel, or the like. Also, the output unit 10c is an output terminal from which data is output, a display, or the like. The communication unit 10h is a LAN card or the like controlled by the CPU 10a reading a predetermined program. Further, the RAM 10d is a static random access memory (SRAM), a dynamic random access memory (DRAM), or the like and has a program area 10da in which a predetermined program is stored and a data area 10db in which various types of data are stored. Also, the auxiliary storage device 10f is, for example, a hard disk, a magneto-optical (MO) disc, a semiconductor memory, or the like and has a program area 10fa in which a predetermined program is stored and a data area 10fb in which various types of data are stored. In addition, the bus 10g connects the CPU 10a, the input unit 10b, the output unit 10c, the RAM 10d, the ROM 10e, the communication unit 10h, and the auxiliary storage device 10f to each other so that information can be exchanged. The CPU 10a writes a program stored in the program area 10fa of the auxiliary storage device 10f to the program area 10da of the RAM 10d in accordance with an operating system (OS) program read. Similarly, the CPU 10a writes various types of data stored in the data area 10fb of the auxiliary storage device 10f into the data area 10db of the RAM 10d. Then, addresses on the RAM 10d in which this program or data is written are stored in the register 10ac of the CPU 10a. The control unit 10aa of the CPU 10a sequentially reads these addresses stored in the register 10ac, reads the program or data from the area on the RAM 10d indicated by the read addresses, causes the arithmetic unit 10ab to sequentially execute operations indicated by the program, and stores the operation result in the register 10ac. With such a configuration, functional configurations of the client devices 11-n and 21-n and the secure computation devices 12-m and 22-m are realized.

The above-described program can be recorded on a computer-readable recording medium. An example of the computer-readable recording medium is a non-transitory recording medium. Examples of such a recording medium include a magnetic recording device, an optical disc, a magneto-optical recording medium, a semiconductor memory, and the like.

The program is distributed, for example, by selling, transferring, lending, or the like of portable recording media such as DVDs and CD-ROMs on which the program is recorded. Further, a configuration may be adopted in which the program is stored in a storage device of a server computer and distributed by transferring the program from the server computer to another computer via a network. As described above, the computer executing such a program, for example, first, temporally stores the program stored in the portable recording medium or the program transferred from the server computer in its own storage device. Then, at the time of executing the processing, the computer reads the program stored in its own storage device and executes the processing may be executed in accordance with the read program. Also, as another execution form of the program, the computer may directly read the program from the portable recording medium and execute the processing in accordance with the program, or each time the program is transferred from the server computer to the computer, processing may be executed sequentially in accordance with the received program. In addition, a configuration may be adopted in which the above-described processing is executed by a so-called application service provider (ASP) type service which does not transfer the program from the server computer to the computer and realizes processing functions only by issuing execution instructions and acquiring the results. Further, each processing may be executed in accordance with a smart contract function on a blockchain platform. Also, the program in the present form is assumed to include information that is used for processing by an electronic computer and is equivalent to a program (such as data that is not a direct command to the computer but has a property for defining processing of the computer).

Although the present device is configured by executing a predetermined program on a computer in each embodiment, at least a part of the processing content may be implemented by hardware.

Also, the present invention is not limited to the above-described embodiments. For example, the above-described various processing may not only be executed in chronological order as described, but may also be executed in parallel or individually depending on the processing capacity of the device that executes the processing or as needed. In addition, it is needless to say that changes can be made as appropriate without departing from the gist of the present invention.

### REFERENCE SIGNS LIST

1, 2 Secure computing system
11-n, 21-n Client device
12-m, 22-m Secure computing device
13 Cloud

1. A computing device serving as a node of a blockchain comprising processing circuitry configured to:
execute processing for obtaining consensus using a consensus algorithm of the blockchain; and
store, in a block of the blockchain, a one-way function value of at least one of secret information obtained by securely distributing information based on original information and a secure computation result obtained by performing secure computation on the secret information in a case in which the consensus is obtained using the consensus algorithm of the blockchain.

2. The computing device according to claim 1, wherein the processing circuitry is further configured to perform the secure computation on the secret information in accordance with a processing request from a smart contract function using the blockchain to obtain the secure computation result.

3. The computing device according to claim 2, wherein
a request other than the processing request from the smart contract function is blocked.

4. The computing device according to claim 1, wherein
a one-way function value of at least one of other secret information obtained by securely distributing information based on the original information and another secure computation result obtained by performing secure computation on the other secret information is stored in a block of another blockchain by another computing device serving as a node for which consensus is obtained using a consensus algorithm of the other blockchain other than the blockchain.

5. The computing device according to claim 1, wherein
a one-way function value of at least one of other secret information obtained by securely distributing information based on the original information and another secure computation result obtained by performing secure computation on the other secret information is stored in a block of the blockchain by another computing device serving as another node for which consensus is obtained using the consensus algorithm of the blockchain.

6. The computing device according to claim 5, wherein
the consensus for the computing device and the other computing device is obtained in parallel using the consensus algorithm of the blockchain, and
the processing circuitry stores at least one one-way function value of the secret information and the secure computation result in the block of the blockchain in which at least one one-way function value of the other secret information and the other secure computation result is stored by the other computing device.

7. The computing device according to claim 5, wherein
after the consensus for the other computing devices is obtained using the consensus algorithm of the blockchain, the consensus for the computing devices is obtained using the consensus algorithm of the blockchain, and
after the consensus for the computing device is obtained using the consensus algorithm of the blockchain, the computing device performs the secure computation on the secret information to obtain the secure computation result, the other computing device performs the secure computation on the other secret information to obtain the other secure computation result, and the one-way function value of the secure computation result and the other secure computation result are stored in the block of the blockchain by the computing device.

8. The computing device according to claim 5, wherein
after the consensus for the other computing device is obtained using the consensus algorithm of the blockchain, the one-way function value of the other secret information is stored in the block of the blockchain by the other computing device,
after the one-way function value of the other secret information is stored in the block of the blockchain by the other computing device, the consensus for the computing device is obtained using the consensus algorithm of the blockchain, and
after the consensus for the computer device is obtained using the consensus algorithm of the blockchain, the computer device performs the secure computation on the secret information to obtain the secure computation result, the other computer device performs the secure computation on the other secret information to obtain the other secure computation result, and the computing device stores the one-way function value of the secret information, the one-way function value of the secret computing result, and the other secret computing result in the block of the blockchain.

9. The computing device according to claim 1, wherein
the original information is information identifying an aggregated model in federated learning,
the information based on the original information is information identifying a worker model obtained by updating the aggregated model by machine learning, and
the secure computation is computing configured to obtain the secure computation result, which is secret information of the information identifying the aggregated model obtained by aggregating a plurality of worker models, using the secret information, without obtaining the worker model.

10. A computing method performed by a computing device serving as a node of a blockchain, comprising:
executing processing for obtaining consensus using a consensus algorithm of the blockchain; and
storing, in a block of the blockchain, a one-way function value of at least one of secret information obtained by securely distributing information based on original information and a secure computation result obtained by performing secure computation on the secret information in a case in which the consensus is obtained using the consensus algorithm of the blockchain.

11. A non-transitory computer-readable recording medium storing a program causing a computer to function as the computing device according to claim 1.
